(19) United States
(12) Patent Application Publication
(10) Pub. No.: US 2025/0147308 A1
(43) Pub. Date: May 8, 2025

(54) HEAD-UP DISPLAY

(71) Applicant: HYUNDAI MOBIS CO., LTD., Seoul (KR)

(72) Inventor: Hyun Woo KANG, Seongnam-si (KR)

(73) Assignee: HYUNDAI MOBIS CO., LTD., Seoul (KR)

(21) Appl. No.: 18/903,384

(22) Filed: Oct. 1, 2024

(30) Foreign Application Priority Data
Nov. 3, 2023 (KR) 10-2023-0151133

(51) Int. Cl. G02B 27/01

(52) U.S. Cl. CPC G02B 27/0101; G02B 27/0149

(57) ABSTRACT

A head-up display including: a screen configured to have a mounting portion formed on a rear surface thereof and an edge contact portion formed on at least one side of the mounting portion; an LCD configured to have a display unit that outputs an image of the head-up display and an edge unit that surrounds the display unit; a diffuser disposed at a rear side of the LCD; and an LCD cover disposed at a rear side of the diffuser and configured to be coupled to the screen to fix the LCD to the screen, wherein the LCD cover includes a plurality of tensioners configured to apply pressure to a rear surface of the diffuser to transfer pressure to the LCD, wherein the LCD is configured to apply pressure to the screen using pressure received from each of the plurality of tensioners, and wherein in order to transfer heat to the screen, the display unit is configured to surface contact with the mounting portion, and the edge unit is configured to surface contact with the edge contact portion.

### CROSS-REFERENCE TO RELATED APPLICATIONS

The present application claims priority to Patent Application No. 10-2023-0151133, filed on Nov. 3, 2023 in Korea, the entire contents of which are incorporated herein by reference.

### TECHNICAL FIELD

The present disclosure relates to a head-up display.

### BACKGROUND

The content described in this section merely provides background information related to one embodiment of the present disclosure and does not constitute prior art.

Recently, the automobile market has tended to prefer intelligent cars equipped with advanced information technology (IT). Products that enhance driving stability and driver convenience are being released, and among them, head-up displays (HUD) are attracting attention.

A head-up display is a device that displays information on a windshield, which is the front window of a vehicle. The head-up display provides the driver with information such as traffic signals, lane change guidance, whether there are pedestrians in front of the vehicle, navigation, vehicle speed, and remaining fuel level.

Recently, head-up displays using augmented reality technology have been used. These are called augmented reality head-up displays. The augmented reality head-up displays provide information by overlaying virtual images on real images.

The head-up display reflects light emitted from a picture generating unit (PGU) using an aspherical mirror to display it the windshield.

The PGU may include a light source that emits light, a printed circuit board (PCB) on which the light source is placed, a liquid crystal display (LCD) that projects an image, a lens that evenly condenses the light transmitted from the light source onto the LCD, a diffuser that spreads light evenly onto the LCD, and the like.

The LCD absorbs sunlight incident on the head-up display and radiant heat generated from the light source on the PCB, so that the temperature of the LCD rises. If the LCD is continuously exposed to high temperatures, the LCD may deteriorate and its reliability may decrease.

In the past, to solve the problem of LCD deterioration, a rotating structure of an aspherical mirror using an illumination sensor has been applied. The rotation structure of the aspherical mirror using the illuminance sensor is intended to be used as a fail safety function to compensate for malfunctions of the head-up display, but there is a problem that it may be mistaken for a malfunction of the head-up display from the passenger's perspective. Accordingly, there is a need for a method that can effectively dissipate heat and prevent deterioration of the LCD without adversely affecting the user experience.

### SUMMARY

In view of the above, one embodiment of the present disclosure provides a head-up display capable of effectively dissipating heat from an LCD and preventing deterioration of the LCD.

A head-up display comprising: a screen configured to have a mounting portion formed on a rear surface thereof and an edge contact portion formed on at least one side of the mounting portion; an LCD configured to have a display unit that outputs an image of the head-up display and an edge unit that surrounds the display unit; a diffuser disposed at a rear side of the LCD; and an LCD cover disposed at a rear side of the diffuser and configured to be coupled to the screen to fix the LCD to the screen, wherein the LCD cover includes a plurality of tensioners configured to apply pressure to a rear surface of the diffuser to transfer pressure to the LCD, wherein the LCD is configured to apply pressure to the screen using pressure received from each of the plurality of tensioners, and wherein in order to transfer heat to the screen, the display unit is configured to surface contact with the mounting portion, and the edge unit is configured to surface contact with the edge contact portion.

As described above, according to the present embodiment, the head-up display can effectively dissipate heat from the LCD.

In addition, the head-up display can prevent deterioration of the LCD.

### BRIEF DESCRIPTION OF THE DRAWINGS

FIG. 1 is a perspective view showing components of a head-up display according to one embodiment of the present disclosure.

FIG. 2 is an exploded perspective view showing the components of the head-up display according to one embodiment of the present disclosure.

FIG. 3 is a diagram showing an LCD cover according to one embodiment of the present disclosure.

FIG. 4 is a cross-sectional view taken along line A-A′ of FIG. 3.

FIG. 5 is a cross-sectional view taken along line B-B′ in FIG. 3.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

Each element of the apparatus or method in accordance with the present invention may be implemented in hardware or software, or a combination of hardware and software. The functions of the respective elements may be implemented in software, and a microprocessor may be implemented to execute the software functions corresponding to the respective elements.

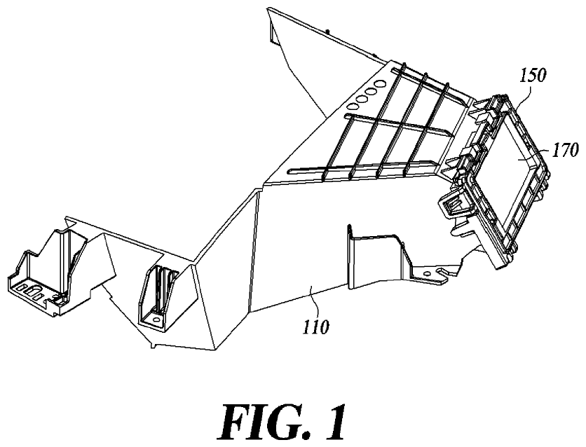

FIG. 1 is a perspective view showing components of a head-up display according to one embodiment of the present disclosure.

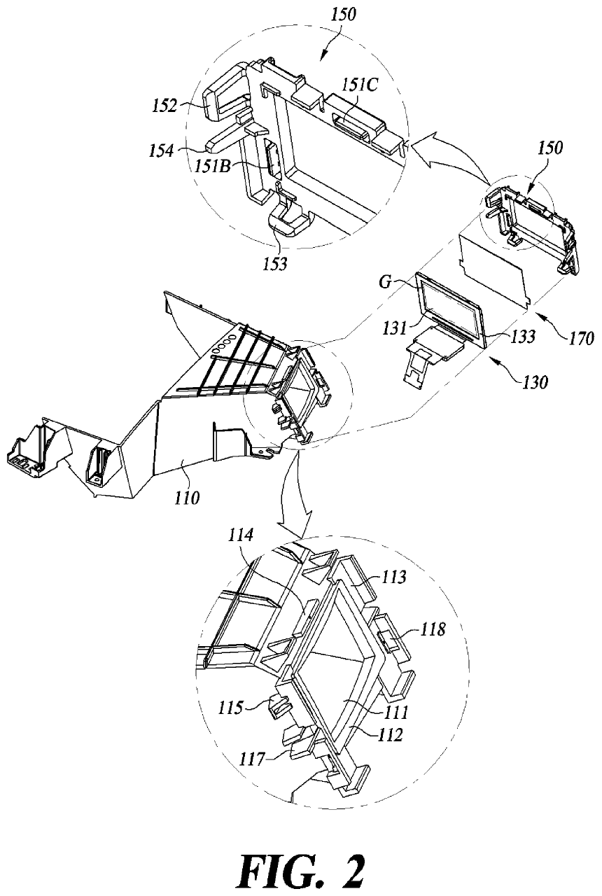

FIG. 2 is an exploded perspective view showing the components of the head-up display according to one embodiment of the present disclosure.

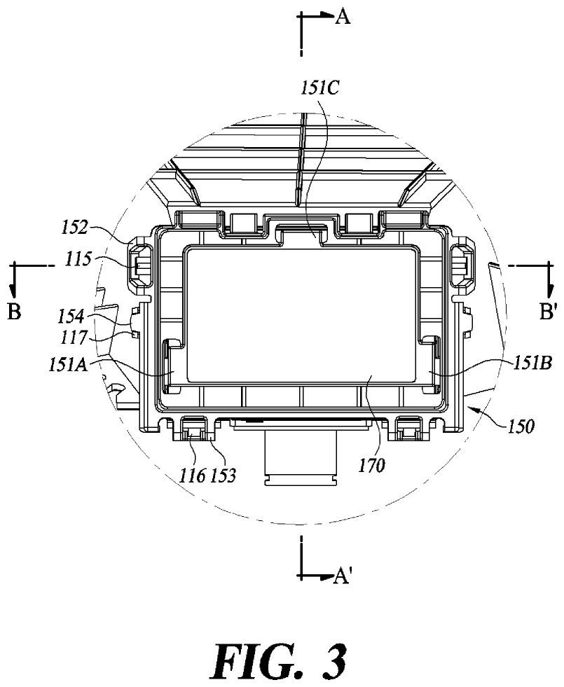

FIG. 3 is a diagram showing an LCD cover according to one embodiment of the present disclosure.

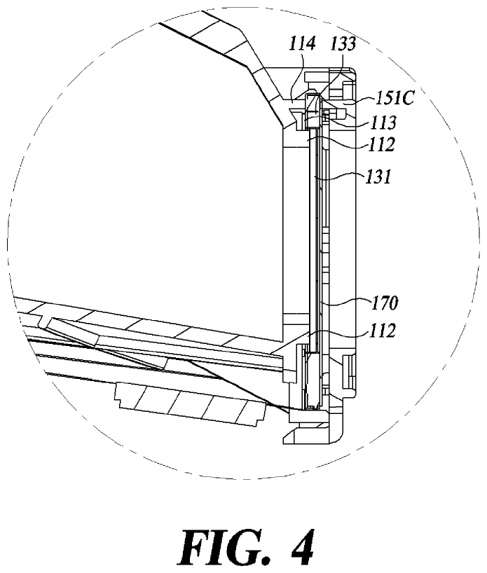

FIG. 4 is a cross-sectional view taken along line A-A′ of FIG. 3.

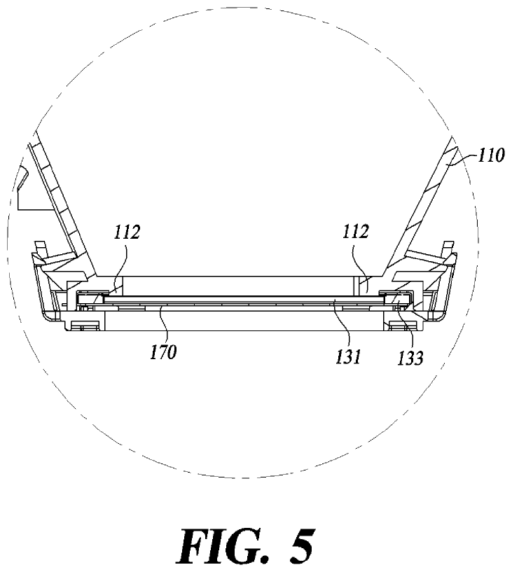

FIG. 5 is a cross-sectional view taken along line B-B′in FIG. 3.

Referring to FIGS. 1 to 5, a head-up display (not shown) according to one embodiment of the present disclosure includes all or some of a screen 110, a liquid crystal display (LCD) 130, a diffuser 170, and a LCD cover 150.

The head-up display according to the present disclosure has a structure that cools the LCD 130 by contacting the LCD 130 and the screen 110 to prevent deterioration of the LCD 130. The LCD 130, the screen 110, the diffuser 170, and the LCD cover 150 according to the present disclosure form a structure to reduce contact conductance.

Contact conductance refers to the resistance that hinders heat transfer at the interface of two objects in contact. Even if two objects appear to be in contact with each other from a macroscopic perspective, heat transfer may not be smooth because the two objects are not completely in close contact from a microscopic perspective.

Contact conductance can be a factor that reduces the heat transfer speed and reduces the efficiency of heat transfer. As the contact heat resistance is minimized, the heat can be transferred efficiently, which allows the LCD 130 to cool quickly.

Conditions for reducing the contact conductance of two objects in contact include reducing the surface roughness of the surfaces in contact, increasing the contact pressure of the surfaces in contact, and using a material with high heat conductivity. In the case of increasing the contact pressure, the two objects come into closer contact, so heat can be easily transferred.

The LCD cover 150 according to the present disclosure may include a plurality of tensioners 151, which will be described later, to generate pressure on the contact surface of the LCD 130 and the screen 110. The contact conductance is reduced due to the pressure applied to the contact surface, allowing heat to be transferred more quickly from the LCD 130 to the screen 110.

The directions used in the present specification are defined. The head-up display generates light using a picture generating unit (PGU) (not shown) and emits the light forward. In the present specification, front and rear are defined based on the movement path of light generated by the PGU. In this case, front and rear are relative concepts. Since light moves from the rear to the front, the screen 110 is placed at the front and the LCD cover 150 is placed at the rear. Among the surfaces of components of the head-up display, the surface arranged to face forward is defined as a front surface, and the surface facing rearward is defined as a rear surface.

The LCD cover 150 is disposed at the rear of the diffuser 170. The LCD cover 150 can be coupled to the screen 110 to fix the LCD 130 to the screen 110.

The LCD cover 150 may include a plurality of tensioners 151. The plurality of tensioners 151 improve the contact force between the LCD 130 and the screen 110 to reduce contact conductance and improve heat dissipation performance.

The plurality of tensioners 151 may be configured to apply pressure to a rear surface of the diffuser 170 to transfer pressure to the LCD 130. According to one embodiment, the plurality of tensioners 151 may protrude from the LCD cover 150. The plurality of tensioners 151 may be arranged to be spaced apart from each other. The plurality of tensioners 151 may include a first tensioner 151A, a second tensioner 151B, and a third tensioners 151C.

According to one embodiment, the first tensioner 151A and the second tensioner 151B may be disposed on both sides of the LCD cover 150 to face each other. The third tensioner 151C may be formed on another side of the LCD cover 150.

According to one embodiment, the first to third tensioners 151A to 151C may be configured to protrude forwardly to press against the rear surface of the diffuser 170. According to one embodiment, ends of the first to third tensioners 151A to 151C may form a surface to be in surface contact with the rear surface of the diffuser 170.

According to one embodiment, the first to third tensioners 151A to 151C may apply pressure by pressing the rear surface of the diffuser 170. The pressure generated by the pressurizing action of the first to third tensioners 151A to 151C may also be transferred to the LCD 130. This is because the pressure from the plurality of tensioners 151 is applied through the diffuser 170 to the LCD 130. The LCD 130 can apply pressure to the screen 110 using the pressure from the first to third tensioners 151A to 151C. The pressure on the screen 110 is formed by the pressing action of the first to third tensioners 151A to 151C. In other words, a compressive force is applied on the contact surface between the LCD 130 and the screen 110 by the first to third tensioners 151A to 151C, so that the LCD 130 and the screen 110 may be pressed against each other. The contact conductance may be reduced by the pressure applied on the contact surface of the LCD 130 and the screen 110.

In other words, the heat of the LCD 130 can be dissipated more quickly through the first to third tensioners 151A to 151C. Since the increased pressure reduces the contact conductance, the LCD 130 may transfer heat to the screen 110 more quickly. The faster the heat from the LCD 130 is dissipated, the less degradation occurs to the LCD 130, allowing the performance of the heads-up display to be maintained for a longer period of time.

The LCD cover 150 may include a pair of first hooks 152. According to one embodiment, the pair of first hooks 152 may be formed on both sides of the LCD cover 150 to face each other. The pair of first hooks 152 may be coupled with a pair of first hook coupling portions 115 formed on both side of the screen 110 to face each other. The pair of first hooks 152 and the pair of first hook coupling portions 115 may be snap-fitted to each other.

The LCD cover 150 may include a pair of second hooks 153. According to one embodiment, the pair of second hooks 153 may be formed on opposite sides of the LCD cover 150. The pair of second hooks 153 may be coupled with a pair of second hook coupling portions 116 formed on another side of the screen 110. The pair of second hooks 153 and the pair of second hook coupling portions 116 may be snap-fitted to each other.

The LCD cover 150 may include a pair of cover guides 154. According to one embodiment, the pair of cover guides 154 may be formed on both sides of the LCD cover 150. According to one embodiment, each of the pair of cover guides 154 may protrude forward from both sides of the LCD cover 150. The pair of cover guides 154 may be engaged with a pair of cover guide grooves 117. The pair of cover guides 154 may include at least one protrusion inserted into the pair of cover guide grooves 117.

The diffuser 170 is disposed at the rear of the LCD 130. The diffuser 170 may control light so that the light generated from the light source of the PGU is evenly incident on the LCD 130. According to one embodiment, the diffuser 170 may be manufactured in a shape and size that corresponds to at least a portion of the LCD 130.

According to one embodiment, in order to reduce contact conductance, the diffuser 170 is configured to press the LCD 130 using the pressure received from the plurality of tensioners 151.

According to one embodiment, the diffuser 170 may include a pair of diffuser guides 171 protruding from both sides. The position of the pair of diffuser guides 171 may be fixed by engaging with a pair of diffuser guide grooves 118 formed on both sides of the screen 110.

The LCD 130 is disposed between the screen 110 and the diffuser 170. The LCD 130 is disposed at the rear of the screen 110. The LCD 130 projects an image using light generated from the light source of the PGU. Since the LCD 130 is in contact with the screen 110, heat generated from the LCD 130 may be transferred to the screen 110. The LCD 130 may be configured to apply pressure to the screen 110 using the pressure received from each of the plurality of tensioners 151. The heat generated from the LCD 130 can be transferred to the screen 110 more quickly by the pressure.

The LCD 130 may include a display unit 131. The display unit 131 is formed at the center of the LCD 130. The display unit 131 projects an image of the head-up display using light generated from the light source of the PGU.

A front surface of the LCD 130 may be in surface contact with the rear surface of the screen 110. Specifically, the display unit 131 may be in surface contact with a mounting portion 112 formed on the screen 110 to transfer heat to the screen 110. According to one embodiment, a portion of the display unit 131 that makes surface contact with the mounting portion 112 may be formed along the edge of the display unit 131 (FIGS. 4 and 5). The edge may correspond to portion G indicated by a dotted line in FIG. 2. Unlike that shown in the drawing, the surface contact portion between the display unit 131 and the mounting portion 112 may not be limited to the edge portion of the display unit 131. According to one embodiment, the edge portion of the display unit 131 may not be used when projecting an image of the head-up display. That is, the LCD 130 can be cooled more quickly by configuring the unused edge of the display unit 131 to contact the mounting portion 112 of the screen 110. According to one embodiment, the mounting portion 112 may protrude rearwardly to easily make surface contact with the display unit 131. When pressure is generated by the plurality of tensioners 151, the display unit 131 and the mounting portion 112 come into close contact with each other to reduce contact conductance, so that the LCD 130 can dissipate heat more efficiently. That is, the display unit 131 can transfer more heat per unit time to the mounting portion 112 when pressure is applied than when pressure is not applied. Heat generated from the display unit 131 may be transferred to an edge unit 133.

The LCD 130 may include the edge unit 133. The edge unit 133 may be formed to surround the display unit 131. According to one embodiment, the edge unit 133 may be configured to make surface contact with an edge contact portion 113 formed on the screen 110 in order to transfer heat to the screen 110. According to one embodiment, the edge unit 133 may be configured to make surface contact with a support portion 114 formed on the screen 110 to transfer heat to the screen 110.

The screen 110 is disposed in front of the LCD 130. The screen 110 may be configured to contact the LCD 130 and receive heat from the LCD 130. A compressive force may be applied to the contact surface between the screen 110 and the LCD 130 by the plurality of tensioners 151. Since contact conductance is reduced by compression force, the screen 110 can receive heat from the LCD 130 more efficiently. In this case, the temperature of the LCD 130 may decrease faster than when no compression force is applied.

The screen 110 may include a pair of first hook coupling portions 115. According to one embodiment, the pair of first hook coupling portions 115 may be formed on both sides of the screen 110 to face each other. The pair of first hook coupling portions 115 may be coupled to the pair of first hooks 152.

The screen 110 may include a pair of second hook coupling portions 116. According to one embodiment, the pair of second hook coupling portions 116 may be formed on another side of the screen 110. The pair of second hook coupling portions 116 may be coupled to the pair of second hooks 153.

The screen 110 may include a pair of cover guide grooves 117. According to one embodiment, the pair of cover guide grooves 117 may be formed on both sides of the screen 110. The pair of cover guide grooves 117 may be engaged with a pair of cover guides 154.

The protruding length of the pair of cover guides 154 may be longer than the depth of the pair of cover guide grooves 117. In this case, the stability of the coupling of the screen 110 and the LCD cover 150 can be improved.

The screen 110 may include a pair of diffuser guide grooves 118. According to one embodiment, the pair of diffuser guide grooves 118 may be formed on both sides of the screen 110. The pair of diffuser guide grooves 118 may be engaged with the pair of diffuser guides 171. The position of the diffuser 170 can be stably fixed by engaging the pair of diffuser guides 171 and the pair of diffuser guide grooves 118.

The screen 110 may include a hole 111. The hole 111 may be formed at the center of the rear surface of the screen 110. The image of the head-up display projected from the LCD 130 may pass through the hole 111.

The screen 110 may include a mounting portion 112. The mounting portion 112 may be formed on the rear surface of the screen 110. The mounting portion 112 may be formed to surround the hole 111. The mounting portion 112 may be located between the hole 111 and the edge contact portion 113. The mounting portion 112 may be in surface contact with the display unit 131 to absorb heat from the display unit 131. The mounting portion 112 may protrude rearward from the rear surface of the screen 110 to make surface contact with the display unit 131.

According to one embodiment, the mounting portion 112 may make surface contact with an edge portion of the display unit 131. In this case, the edge portion of the display unit 131 may be a portion that is not used when projecting the image of the head-up display. That is, the mounting portion 112 is configured to contact the edge portion of the display unit 131 that is not used when projecting the image of the head-up display, so that the mounting portion 112 can receive heat from the display unit 131 more efficiently.

Pressure from the plurality of tensioners 151 is applied to the mounting portion 112. Due to pressure, the mounting portion 112 comes into close contact with the display unit 131 and can receive heat from the display unit 131 more effectively.

The screen 110 may include an edge contact portion 113. According to one embodiment, the edge contact portion 113 may be formed on at least one side of the mounting portion 112. According to one embodiment, the edge contact portion 113 may be formed to surround the mounting portion 112 along the periphery of the mounting portion 112. The edge contact portion 113 may be configured to make surface contact with the edge unit 133. The edge contact portion 113 may receive heat from the edge unit 133 by making surface contact with the edge unit 133. Since the edge unit 133 is configured to absorb heat generated from the display unit 131, and the edge contact portion 113 is configured to absorb heat from the edge unit 133, the edge unit 133 and the edge contact portion 113 serve to prevent deterioration of the LCD 130.

Pressure from the plurality of tensioners 151 is applied to the edge contact portion 113. Due to the pressure, the edge contact portion 113 comes into closer contact with the edge unit 133 and can receive heat from the edge unit 133 more effectively.

The screen 110 may include at least one support portion 114. The support portion 114 may be configured to support the front surface of the LCD 130.

According to one embodiment, the support portion 114 may be arranged to be spaced a predetermined distance away from the mounting portion 112. According to one embodiment, the support portion 114 may be formed to extend long on the rear surface of the screen 110. The longer the support portion 114 is formed, the more stably the position of the LCD 130 disposed on the rear surface of the screen 110 is fixed.

According to one embodiment, the support portion 114 may be disposed in front of the third tensioner 151C. In this case, the support portion 114 may support the front surface of the LCD 130 so that the LCD 130 is not bent more than a predetermined angle due to the pressing action of the third tensioner 151C (FIG. 4). The support portion 114 provides a reaction force to the LCD 130 against the pressing action of the third tensioner 151C. That is, when the third tensioner 151C presses the rear surface of the LCD 130, the support portion 114 presses the front surface of the LCD 130.

According to one embodiment, the support portion 114 may be in surface contact with the edge unit 133 of the LCD 130 (FIG. 4). When an external force is applied by the third tensioner 151C, the support portion 114 can press the edge unit 133, and the support portion 114 can effectively absorb heat generated from the edge unit 133. This is because the pressure on the contact surface between the support portion 114 and the edge unit 133 increases and the contact conductance decreases.

According to one embodiment, at least a portion of the screen 110 may be made of heat dissipation plastic. The heat conductivity of the heat dissipation plastic may be 15 W/mK or more, and preferably 20 W/mK or more. The heat resistance temperature of the heat dissipation plastic may be 130° C. or more. The flexural strength of the heat dissipation plastic may be 1000 kgf/cm² or more.

The head-up display according to the present disclosure can improve the thermal performance of the LCD 130 by increasing the pressure on the portion where the LCD 130 and the screen 110 are in contact to reduce the contact conductance using the plurality of tensioners 151.

As described above, the LCD cover 150 and the screen 110 are hooked together using the plurality of hooks 152 and 153 and the plurality of hook coupling portions 115 and 116. The hook coupling further improves the contact force between the LCD 130 and the screen 110, which reduces the contact conductance and contributes to improving the heat dissipation performance of the LCD 130.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

What is claimed is:

1. A head-up display comprising:
a screen configured to have a mounting portion formed on a rear surface thereof and an edge contact portion formed on at least one side of the mounting portion;
a liquid crystal display (LCD) configured to have a display unit that outputs an image of the head-up display and an edge unit that surrounds the display unit;
a diffuser disposed at a rear side of the LCD; and
an LCD cover disposed at a rear side of the diffuser and configured to be coupled to the screen to fix the LCD to the screen,
wherein the LCD cover includes a plurality of tensioners configured to apply pressure to a rear surface of the diffuser to transfer pressure to the LCD,
wherein the LCD is configured to apply pressure to the screen using pressure received from each of the plurality of tensioners, and
wherein in order to transfer heat to the screen, the display unit is configured to surface contact with the mounting portion, and the edge unit is configured to surface contact with the edge contact portion.

2. The head-up display of claim 1, wherein the plurality of tensioners include a first tensioner, a second tensioner, and a third tensioner, which protrude from the LCD cover and are spaced apart from each other.

3. The head-up display of claim 2, wherein the first tensioner and the second tensioner are disposed on both sides of the LCD cover to face each other, and
the third tensioner is formed on another side of the LCD cover.

4. The head-up display of claim 1, wherein the LCD cover includes:
a pair of first hooks formed on both sides of the LCD cover to face each other; and
a pair of second hooks formed on another side of the LCD cover,
wherein the pair of first hooks are coupled to a pair of first hook coupling portions formed on both sides of the screen to face each other, and
the pair of second hooks are coupled to a pair of second hook coupling portions formed on another side of the screen.

5. The head-up display of claim 1, wherein the LCD cover further includes a pair of cover guides on both sides,
the screen further includes a pair of cover guide grooves on both sides, and
the pair of cover guides are coupled to the pair of cover guide grooves.

6. The head-up display of claim 1, wherein the diffuser further includes a pair of diffuser guides protruding on both sides,
the screen further includes a pair of diffuser guide grooves on both sides, and
the pair of diffuser guides are coupled to the pair of diffuser guide grooves.

7. The head-up display of claim 1, wherein the screen further includes a support portion disposed at a predetermined distance from the mounting portion, and
the support portion extends long on the rear surface of the screen and supports a front surface of the LCD.

8. The head-up display of claim 1, wherein the mounting portion protrudes from the rear surface of the screen to surround a hole formed in a center of the rear surface of the screen.

9. The head-up display of claim 1, wherein a portion of the display unit, which is in surface contact with the mounting portion, is formed along an edge of the display unit.

10. The head-up display of claim 2, wherein the screen further includes a support portion supporting a front surface of the LCD, and
the support portion is disposed in front of the third tensioner and supports the front surface of the LCD so that the LCD is not bent more than a predetermined angle due to the pressing action of the third tensioner.
